(19) United States
(12) Patent Application Publication
(10) Pub. No.: US 2004/0091682 A1
(43) Pub. Date: May 13, 2004

(54) Composite material

(76) Inventor: Fritz Brinkmann, Rettenbach (DE)

Correspondence Address: JORDAN AND HAMBURG LLP, 122 EAST 42ND STREET, SUITE 4000, NEW YORK, NY, 10168, US

(21) Appl. No.: 10/471,331

(22) PCT Filed: Jan. 23, 2002
(86) PCT No.: PCT/EP02/00649

(30) Foreign Application Priority Data
Mar. 8, 2001 (DE) 101 11 038.3

(51) Int. Cl. B32B 3/00

(52) U.S. Cl. 428/195.1

(57) ABSTRACT

The invention relates to a composite material, comprising at least one support layer and at least one adhesive film the non-adhesive upper surface of which can be at least partially printed and/or at least partially painted and/or at least partially written on and/or at least partially coloured and/or at least partially provided with information and the adhesive underside of which is detachably arranged on the upper surface of the support layer.

The present invention relates to a composite material.

Such composite materials, which can also function as information or advertising carriers, depending on their respective use, are sold, for example, as decals or also as labels in stationery or toys commerce.

In this connection, decals or labels are known, which are coated on their respective underside at least sectionaly and/or regionally with adhesive and are intended to be applied decoratively on an object, such as a bed or a windowpane in a nursery or child's room.

It should be noted that with respect to known decals or labels that these are based primarily on being applied by means of an adhesive. If such decals or adhesives are to be removed once again after a considerable time from the object, such as a bed or a windowpane in a nursery or a child's room, unsightly residues of adhesives, which affect the object not only visually, frequently remain behind.

In the case of decals and labels, based on an application with adhesives, difficulties also arise time and again as result of inadequate dispensability and as a result of deficient recyclability of the decal or label which has been removed.

Starting out from the disadvantages and shortcomings presented above, it is an object of the invention to make available a composite material, which enables the decal to be affixed easily and without problems to the respective object, such as a bed or a windowpane in a nursery or a child's room.

Moreover, it is an object of the present invention to make available a composite material for which the decal or the label can be removed once again from a respective object readily and without leaving any residue adhesive from the and, after being removed, can be recycled relatively inexpensively and without harming the environment.

For a composite material of the type named above, this objective is accomplished owing to the fact the composite material, according to the teachings of the present invention, has at least one backing layer, as well as at least one pressure-sensitive film, on the non-adhesive upper side of which it is possible, at least partially, to print and/or to paint and/or to inscribe and/or to color and/or to provide with information and the adhesive underside of which is detachably disposed on the underside of the backing layer.

Since the composite material of the teachings of the present invention has at least one pressure-sensitive film and since it is therefore possible to do without any form of adhesive between the underside of the pressure-sensitive film and the upper side of the backing layer, it is surprisingly ensured that the pressure-sensitive film can be pulled off completely from the backing layer without distortions under any conditions and applied at the desired place of an object.

In this connection, those skilled in the art, in particular, will appreciate that, when the pressure-sensitive film is to be removed once again after some considerable time from the object, such as a bed or a windowpane in a nursery or child's room, no unsightly adhesive residues, which will affect the object not only visually, will remain on the latter. This is based on the inventive property that, in case of the present composite material, there is no adhesive whatsoever between the underside of the pressure-sensitive film and the upper side of the backing layer.

Moreover, if necessary, the property of pressure-sensitive films, explained above, also makes possible a simple and problem-free automatic and/or mechanical dispensing of the pressure-sensitive film, which is constructed, for example, approximately rectangularly in plan view, on the respective object by means of a dispenser, which is designed for this purpose.

In this connection, those skilled in the art, in particular, will appreciate that the paper and/or the cardboard-containing backing material for the pressure-sensitive film, contain, for example, a plastic (such as one from the group of polyamides (PA), the polyethylenes (PE), the polyethylene terephthalates (PET), the polypropylenes (PP), the polystyrenes (PS) and/or the polyurethanes (PU)) and does not necessarily have to be siliconized or otherwise pretreated on the side facing the pressure-sensitive film, so that, in accordance with the teachings of the present invention, not only pressure-sensitive film itself, but also the backing material can be recycled relatively inexpensively and without harming the environment and therefore returned to the material cycle.

Likewise, it is conceivable in a potential embodiment of the present composite material to coat the upper side of the backing layer with at least one lacquer and/or with silicone, in order to facilitate further the process of the residue-free detachment of the pressure-sensitive film from the backing layer.

Moreover, the pressure-sensitive film property not only favors the fact that individual figures and/or motifs, such as comic pictures, puzzle parts or the like, which can be pulled from the backing and, in particular, detached without leaving a residue, can be stamped out from the appropriately sheet-shaped (endless) pressure-sensitive film, for example, by means of a flat or rotary punch, but also the fact that the pressure-sensitive film, a short time or also a long time after it has been applied, can be removed without problems and without leaving residue (of adhesive) from the respective object, such as a bed or a windowpane in a nursery or a child's room.

In accordance with a particularly inventive further development, the pressure-sensitive film, particularly the upper side of the pressure-sensitive film, is provided at least partially with at least one embossing. By these means, the degree and/or the strength of the adhesion of the pressure-sensitive film at the adhesive object can be adjusted and fixed. Alternatively or in addition, the composite material as a whole can be provided at least partially with at least one perforation and/or the pressure-sensitive film can be provided with at least one notching.

Pursuant to a preferred embodiment of the present invention, the pressure-sensitive film is formed in one layer from thermoplastic material, which has at least two different plastics. By these means, the material-specific properties can be adjusted and parameterized individually in a practical manner, depending on the particular use to which the composite material is to be put. For example, the pressure-sensitive film may have material regions which extend parallel to one another in the extrusion direction and which, in turn, may have a first plastic and a second plastic in alternation.

In an advantageous embodiment, the pressure-sensitive film is stretched, particularly axially or biaxially, in order to impart to the composite material the stiffness desired for the further processing, especially for the dispensing on the respective object.

Particularly advantageous properties of the composite material can be achieved if, in accordance with an appropriate further development of the present invention

the upper side of the pressure-sensitive film is formed from a first plastic,

the underside of the pressure-sensitive film is formed from a second plastic and

the upper side and the underside are co-extruded or laminated together by at least one interconnecting agent, such as a coupling agent.

In this connection, the first plastic may be selected from the group comprising polyamides (PA), polyethylenes (PE), polyethylene terephthalates (PET), polypropylenes (PP), polystyrenes (PS) and/or polyurethanes (PU), where as the second plastic, independently of the first plastic or in conjunction with the first plastic, can be selected from the group comprising ethylene butyl acrylates (EBA), ethylenemethyl acrylates (EMA), ethylene vinyl acrylates (EVA), polyisobutyls (PIB), polyisyomethyls (PIM), polyisovinyls (PIV) and/or Surlyn.

In this connection, it may be noted that the second plastic, which advantageously brings about the adhesive properties of the pressure-sensitive film, is added in the form of approximately 20% ethylene vinyl acrylate (EVA) up to about 60% ethylene vinyl acrylate (EVA), for example in the form of approximately 56% ethylene vinyl acrylate (EVA), or in the form of an approximately 4% polyisobutyl (PIB) (resulting in a melt index MI of about 1).

The aforementioned interconnecting agent may be based appropriately on at least one copolymer. In particular, the material of the interconnecting agent may be selected from the group comprising ethylene butyl acrylates (EBA), ethylenemethyl acrylates (EMA), ethylene vinyl acrylates (EVA) and/or Surlyn.

In order to ensure a particularly intimate connection between the first plastic and the second plastic, the melting temperature T_{V} of a preferred embodiment of the interconnecting agent (for example, in the order of about 120° C.) is lower than the melting temperature T_{K} of the first plastic and of the second plastic (for example, in the order of about 220° C).

Alternatively or in addition thereto, at least one adhesive, such as

at least one cold-setting adhesive and/or

at least one thermally effective adhesive (a so called hot melt adhesive) may be provided as an interconnecting agent. In the final analysis, the choice of an adequate interconnecting agent will depend on the intended use and on the material properties which the composite material is required to have.

As already explained above, the pressure-sensitive film, in accordance at least one further particularly inventive development, has an imprint. With this imprint, it is possible to impart not only general information, but also selective information concerning particular advertising measures (sweepstakes, price competitions, special offers, free offerings, . . . ); in this connection, it may be advantageous if the composite material is at least partially opaque and/or at least partially transparent.

Since the non-adhesive upper side of the pressure-sensitive film of the teachings of the present invention can be printed upon and/or painted and/or inscribed and/or dyed and/or provided with information at least partially, it is advisable to coat this upper side of the pressure-sensitive film at least partially with a liquid-absorbing material and/or at least partially with at least one substrate containing a titanium dioxide (TiO₂).

By means of such a substrate, which contains a high proportion of chalk, it is ensured that children can decorate the upper side of the pressure-sensitive film with colored pencils, crayons or water colors and apply it in pictorial form, stamped out by the manufacturer (for example, as a so-called “Pokemons” or so-called “Digimons”) at windowpanes or at a similar substrate, without having bothersome residues remain on the substrate when the stamped-out pressure-sensitive film motif is detached at later time.

Due to the fact that the present pressure-sensitive film is “food-resistant”, it can be used not only for children, but also for adults.

According to a further example of a possible use, housewives or the like, who bottle their own marmalade, can provide the glass container, in which the marmalade is kept, with decals or labels stamped-out from the pressure-sensitive film and inscribe the contents of the glass container on these decals or labels using felt pen or a ballpoint pen.

When the glass jar is empty and is to be filled with a different content, the old label, which has become irrelevant to the contents, can be removed from the glass container without leaving any residue and a different label, describing the new contents, stamped-out from the pressure-sensitive tape and detached from the backing layer can be applied on the glass container.

In order to realize the aforementioned possible uses, it may be advantageous for the manufacturer

to at least color the pressure-sensitive film preferably white and/or

to at least partially print the pressure-sensitive film preferably with a white color and/or

to at least partially coat the pressure-sensitive film preferably with a white paint, in order to set off the printable region of the pressure-sensitive film or the printable area of the pressure-sensitive film better.

In accordance with an appropriate further development of the present invention, the printable region of the pressure-sensitive film or the printable area of the pressure-sensitive film can be printed by letterpress printing and/or flexographic printing and/or counter-pressure printing and/or by offset printing and/or by screen-printing and/or by gravure printing.

Alternatively or in addition thereto, the printable region or the pressure-sensitive film or the printable area of the pressure-sensitive film can be printed by means of laser printing and/or by means of thermal transfer printing and/or by means of inkjet printing.

Especially when the composite material is constructed approximately rectangularly in plan view in accordance with a preferred embodiment of the present invention, an essentially blockwise construction, comparable in structure to a thumbcinema, may be of advantage.

Advisably, in the case of such a blockwise construction, individually shaped or spatially configured elements of the composite material are disposed in several layers, one above the other, and connected detachably with one another at least at one side edge, so that the decals or labels can be detached individually from the block and used according to the intended purpose.

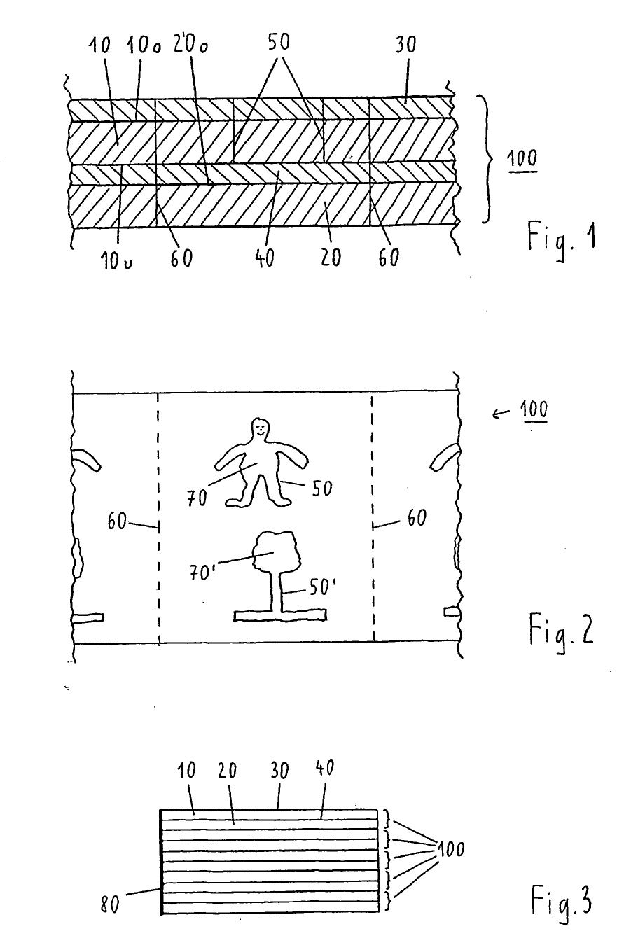

Further embodiments, distinguishing features and advantages of the present invention are illustrated below by means of FIGS. 1 to 3, by means of which an example of the composite material is shown in exemplary form.

FIG. 1 shows a first example of a composite material of the present invention in a cross-sectional representation.

FIG. 2 shows the composite material of FIG. 1 in plan view.

FIG. 3 shows a blockwise construction of several layers of composite material of the present invention in a side view.

Identical or similar elements or distinguishing features in FIGS. 1 to 3 are referred to by identical reference numbers.

In FIGS. 1 to 3, the composite material 100, prepared pursuant to the invention, is shown.

The composite material 100 has a pressure-sensitive film 10 with a non-adhesive upper side 10o and an adhesive underside 10u (see FIG. 1). In this connection, this pressure-sensitive film 10 is formed in one layer from a thermoplastic material, which has two different plastics. In particular, the pressure-sensitive film 10, which has been stretched axially or biaxially, has material regions, which extend parallel to one another in the extrusion direction and alternately have a first plastic and a second plastic.

In this connection, the upper side 10o of the pressure-sensitive film 10 is formed from the first plastic, whereas the underside 10u of the pressure-sensitive film is formed from the second plastic. The upper side 10o may be combined with the underside 10u by means of coextruding.

In this connection, the non-adhesive upper side 10o is distinguished by the fact that it can be printed, for example, by means of a laser printer or by means of a thermal transfer printer or by means of an inkjet printer or also illustrated with colored pencils or watercolors.

So that it can be illustrated particularly well, possibly by children, the upper side 10o of the pressure-sensitive film 10 is coated with a liquid-absorbing material 30, namely a substrate containing titanium dioxide (TiO₂) (See FIG. 1). This substrate is distinguished by a relatively high proportion of chalk, and for this reason absorbs felt pen inks or watercolors particularly well. Running or smearing of the colors on the upper side 10o of the pressure-sensitive film is therefore prevented reliably.

As is further more evident form FIG. 1, the material-immanent adhesive underside 10u of the pressure-sensitive film 10 is disposed detachably on the upper side 20o of a backing layer 20. This backing layer 20 is constructed partially from plastic, namely from polystyrene (PS), as well partially from paper and its surface 20o is coated with silicone 40, in order to ensure that the pressure-sensitive film 10 can be detached particularly easily and simply from the backing layer 20.

The ability to detach the pressure-sensitive film 10 particularly simply and easily from the backing layer 20 is advantageous especially if the pressure-sensitive film 10 is provided partially with perforations 50 (see FIGS. 1 and 2). In some cases, it may be meaningful technically, to die-cut the pressure-sensitive film 10 flat, whereas in other cases a rotational die-cutting may be recommendable. In this connection, the pressure-sensitive film 10 is die-cut in the form of FIGS. 70 and motifs 70′ (see FIG. 2), perhaps in the shape of selected elements of the so-called “Pokemon” group, which can be pulled off from the backing layer 20 without leaving a residue.

In addition thereto, the pressure-sensitive film 10 can be provided with embossings. By these means, the degree and strength of the adhesion of the pressure-sensitive film 10 to the respective object, such as a bed or a windowpane in a nursery or a child's room, can be adjusted and fixed.

For the latter exemplary case of the application of the pressure-sensitive film 10 at a windowpane, the composite material 100 and, in this case, particularly the pressure-sensitive film 10, is constructed essentially transparent in order to enable sunlight or light to shine through when the printed or illustrated pressure-sensitive film 10 is mounted at a windowpane. In this case, the attractive and decorative configuration is shown to advantage in a particularly advantageous manner.

As can be inferred from the representation of FIG. 2, the composite material 100 is provided with a continuous perforation 60, which is disposed at regular intervals, in order to ensure that individual parts of the composite material 100 can be severed from one another.

Finally, it shown in FIGS. 2 and 3, that the composite material 100 may be constructed approximately rectagularly. This is manifested in a particularly precise manner in an essentially blockwise construction. This means that individual rectangular elements of the composite material 100 are disposed in several layers above one another and connected detachably from one another at a side edge 80.

1. A composite material (100), having
at least one backing layer (20) as well as
at least one pressure-sensitive film (10)
the non-adhesive upper side (10o) of which can be printed and/ or illustrated and/or inscribed and/or dyed and/or provided with information at least partially and the adhesive underside (10u) of which is disposed detachably on the upper side (200) of the backing layer (20).

2. The composite material (100) of claim 1, characterized in that the pressure-sensitive film (10) and, in particular, the upper side (10o) of the pressure-sensitive film (10), is provided at least partially with at least one embossing.

3. The composite material (100) of claims 1 or 2, characterized in that the pressure-sensitive film (10) is provided at least partially with at least one perforation (50).

4. The composite material (100) of claim 3, characterized in that the pressure-sensitive film (10) is perforated flat or rotationally.

5. The composite material (100) of claims 3 or 4, characterized in that the pressure-sensitive film (10) is perforated in form of figures (70) and/or motifs (70′), such as comic pictures or puzzles parts or the like, which can be pulled off from the backing layer (10).

6. The composite material (100) of at least one of the claims 1 to 5, characterized in that composite material (100) is provided at least partially with at least one perforation (60).

7. The composite material (100) of at least one of the claims 1 to 6, characterized in that the pressure-sensitive film (10) is constructed as a single layer from a thermoplastic material, which has at least two different plastics.

8. The composite material (100) of at least one of the claims 1 to 7, characterized in that the pressure-sensitive film (10) has material regions which extend parallel to one another in the extrusion direction and alternatingly have a first plastic and a second plastic.

9. The composite material (100) of at least one of the claims 1 to 8, characterized in at the pressure-sensitive film (10) is stretched, particularly axially or particularly biaxially.

10. The composite material (100) of at least one of the claims 1 to 9, characterized in that
the upper side (10o) of the pressure-sensitive film (10) is formed from a first plastic,
the underside (10u) of the pressure-sensitive film (10) is formed from a second plastic and
the upper side (10o) and the underside (10u) are co-extruded or laminated to one another by means by at least one interconnecting agent.

11. The composite material (100) of claim 10, characterized in that the first plastic is selected form the group comprising polyamides (PA), polyethylenes (PE), polyethylene terephthalates (PET), polypropylenes (PP), polystyrenes (PS) and/or polyurethanes (PU).

12. The composite material (100) of claims 10 or 11, characterized in that the second plastic is selected from the group comprising ethylene butyl acrylates (EBA), ethylene methyl acrylates (EMA), ethylene vinyl acrylates (EVA), polyisobutyls (PIB), polyisomethyls (PIM), polyisovinyls (PIV), and/or Surlyn.

13. The composite material (100) of at least one of the claims 10 to 12, characterized in that the interconnecting agent is at least one coupling agent.

14. The composite material (100) of at least one of the claims 10 to 13, characterized in that the interconnecting agent is based on at least one copolymer.

15. The composite material (100) of at least one of the claims 10 to 14, characterized in that the material of the interconnecting agent is selected from the group comprising ethylene butyl acrylates (EBA), ethylene methyl acrylates (EMA), ethylene vinyl acrylates (EVA) and/or Surlyn.

16. The composite material (100) of at least one of the claims 10 to 15, characterized in that the melting temperature (T_{V}) of the interconnecting agent is lower than the melting temperature (T_{K}) of the first plastic and of the second plastic.

17. The composite material (100) of claim 16, characterized in that the melting temperature (T_{V}) of the interconnecting agent is in the order of 120° C. and/or the melting temperature (T_{K}) of the first plastic and/or of the second plastic is in the order of 220° C.

18. The composite material (100) of at least one of the claims 10 to 17, characterized in that at least one adhesive is provided as interconnecting agent.

19. The composite material (100) of claim 18, characterized in that the adhesive is at least one cold-setting adhesive and/or at least one thermally effective adhesive (a so-called hot melt adhesive).

20. The composite material (100) of at least one of the claims 1 to 19, characterized in that the composite material (100) is formed at least partially opaque and/or at least partially transparent.

21. The composite material (100) of at least one of the claims 1 to 20, characterized in that the upper side (10o) of the pressure-sensitive film (10) is coated at least partially with a liquid-absorbing material (30) and/or at least partially with at least one substrate (30′) containing a titanium dioxide (TiO₂).

22. The composite material (100) of at least one of the claims 1 to 22, characterized in that the printable region of the pressure-sensitive film (10) or the printable area of the pressure-sensitive film (10) can be printed by letterpress and/or flexographic and/or counter-pressure and/or offset and/or screen and/or gravure printing means.

23. The composite material (100) of at least one of the claims 1 to 22, characterized in that the printable region of the pressure-sensitive film (10) or the printable area of the pressure-sensitive film (10) can be printed by means of laser printing and/or thermal transfer printing and/or by means of inkjet printing.

24. The composite material (100) of at least one of the claims 1 to 23, characterized in that the backing (20) is constructed at least partially of plastic and/or at least partially of paper and/or cardboard.

25. The composite material (100) of claim 24, characterized in that the plastic is selected from the group comprising the polyamides (PA), the polyethylenes (PE), the polyethylene terephthalates (PET), the polypropylenes (PP), the polystyrenes (PS) and/or the polyurethanes (PU).

26. The composite material (100) of at least one of the claims 1 to 25, characterized in that the upper side (20o) of the backing (20) is coated with at least one lacquer and/or silicone (40).

27. The composite material (100) of at least one of the claims 1 to 26, characterized in that the composite material (100) is constructed approximately rectangular in plan view.

28. The composite material (100) of at least one of the claims 1 to 27, characterized by an essentially blockwise construction.

29. The composite material (100) of claim 28, characterized in that individually formed or spatially configured elements of the composite material (100) are disposed in several layers one above the other and are connected detachably with one another at least at one side edge (80).
